(19) United States
(12) Patent Application Publication
(10) Pub. No.: US 2008/0317616 A1
(43) Pub. Date: Dec. 25, 2008

(54) Positioning device for a detecting device of a motor of a ceiling fan

(75) Inventor: Tang Yung Yu, Taichung (TW)

Correspondence Address: BRUCE H. TROXELL, SUITE 1404, 5205 LEESBURG PIKE, FALLS CHURCH, VA, 22041, US

(73) Assignee: Air Cool Industrial Co., Ltd.

(21) Appl. No.: 11/812,968

(22) Filed: Jun. 22, 2007

(51) Int. Cl. F01D 25/36; F01D 9/00; H02K 1/14

(52) U.S. Cl. 417/423.7; 417/424.1; 310/254

(57) ABSTRACT

The invention relates to a positioning device of a detecting device of a motor of a ceiling fan. The motor includes a stator, a rotor, a detecting device and a circuit board. The rotor is pivotally installed around a motor shaft provided in the stator. The positioning device includes a plurality of supporting recesses formed in the stator, positioned in preset locations on one surface cut through to its edge of the stator, for fitting precisely the detecting device therein without increasing extra cost.

### BACKGROUND OF THE INVENTION

1. Field of the Invention

This invention relates to a motor of a ceiling fan, particularly to one provided with supporting recesses positioned on preset locations of silica steel plates of its stator, for precisely fitting steadily a detecting device therein.

2. Description of the Prior Art

As shown in FIG. 1, a conventional motor 10 of a ceiling fan is composed of a stator 11, a rotor 12, a detecting device 13 and a circuit board 14. The stator 11 is provided with a motor shaft 111 and a preset number of silica steel plates 112 that are laminated and installed around the motor shaft 111, spaced apart with equidistance. A plurality of sections of the laminated silica steel plates 112 are respectively wound with a magnet coil 1121. The rotor 12 is pivotally fixed around the motor shaft 111 of the stator 11, provided with an upper shell 121, a lower shell 122, an intermediate shell 123 and a preset number of induction magnets 124. The detecting device 13 is commonly fixed on an upper surface of the laminated silica steel plates 112, connected with the circuit board 14 so as to transmit messages of the changes of the magnetic field detected from the induction magnets 124 to the circuit board 14, which can then control the induced magnetic field generated by the magnet coil 1121 to keep the rotor 12 whirling steadily in a same direction. In addition, as shown in FIG. 2, a second conventional motor 20 of a ceiling fan is composed of a stator 21, a rotor 22, a detecting device 23 and a circuit board 24. The rotor 22 is provided with an upper shell 221, a lower shell 222, an intermediate shell 223 and a preset number of induction magnets 224. The internal components are the same as the first conventional one are, except that the detecting device 23 is previously fixed on a bottom of a supporting board 231 and then the combined device is installed above the upper shell 221. In order to enable the detecting device 23 to induce mutually with the induction magnets 224, an extra group of induction magnets 225, having the same magnetism as the induction magnets 224 do, is set between the upper shell 221 and the detecting device 23, so that the detecting device 23 can induce with the induction magnets 225 to transmit signals to the circuit board 24. However, in the first conventional motor 10, the detecting device 13 is stuck on the edge of the silica steel plates 112 by an adhesive that is to lose its adhesion after a period of time, permitting the detecting device 13 detached from the laminated silica steel plates 112 to be out of function. As for the second conventional motor 20, the extra induction magnets 225 not only cause a more complicated assembly, but also increase cost.

### SUMMARY OF THE INVENTION

The objective of this invention is to offer a positioning device for a detecting device of a motor of a ceiling fan.

The main characteristics of the motor are a stator, a rotor, a detecting device and a circuit board. The rotor is pivotally installed around a motor shaft provided in the stator. The stator also contains supporting recesses positioned in preset locations on one surface and cut through to its edge, for fitting precisely the detecting device without increasing extra cost. Moreover, in order to keep the detecting device fixed more deadly in the supporting recesses, an adhesive is additionally coated in the supporting recesses.

### BRIEF DESCRIPTION OF DRAWINGS

This invention is better understood by referring to the accompanying drawings, wherein:

FIG. 1 is a perspective view of a first conventional motor of a ceiling fan;

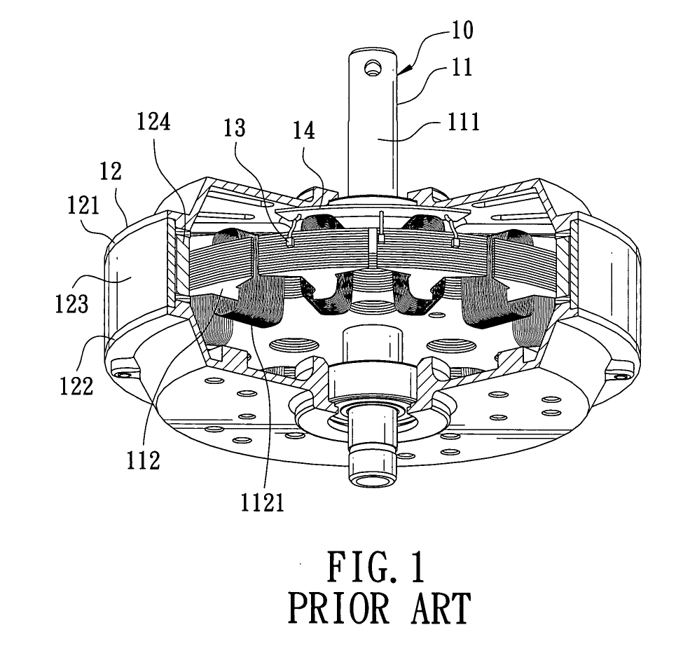

FIG. 2 is cross-sectional view of a second conventional motor of a ceiling fan;

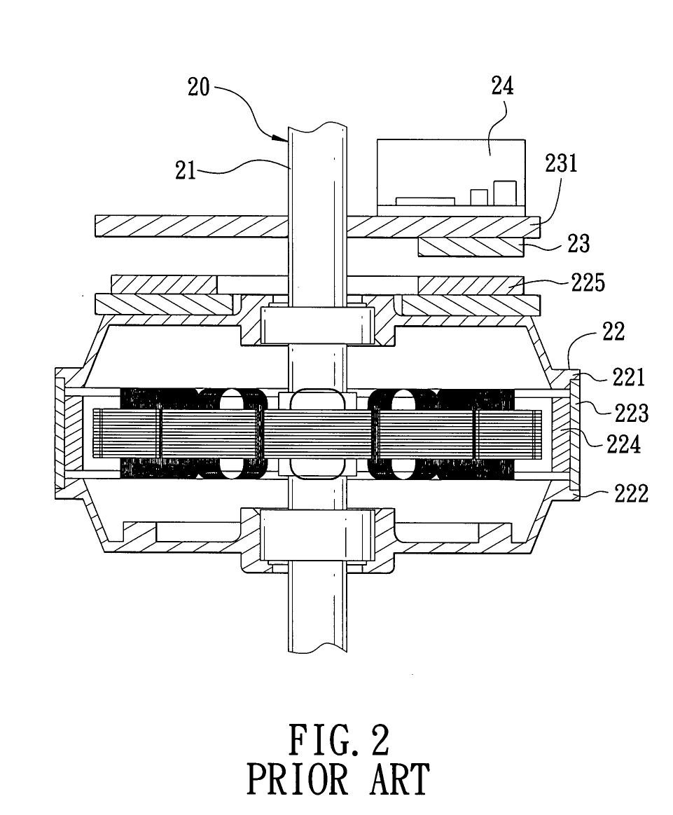

FIG. 3 is a perspective view of a first preferred embodiment of a positioning device for a detecting device of a motor of a ceiling fan in the present invention;

FIG. 4 is a partial exploded perspective view of the first preferred embodiment of a positioning device for a detecting device of a motor of a ceiling fan in the present invention;

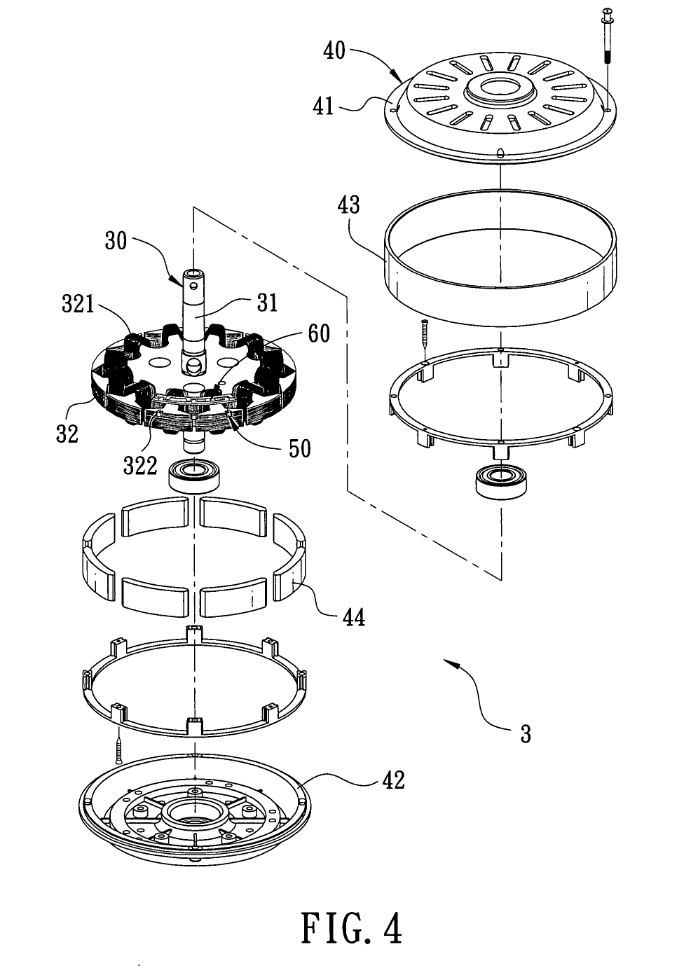

FIG. 5 is a partial cross-sectional view of the first preferred embodiment of a positioning device for a detecting device of a motor of a ceiling fan in the present invention;

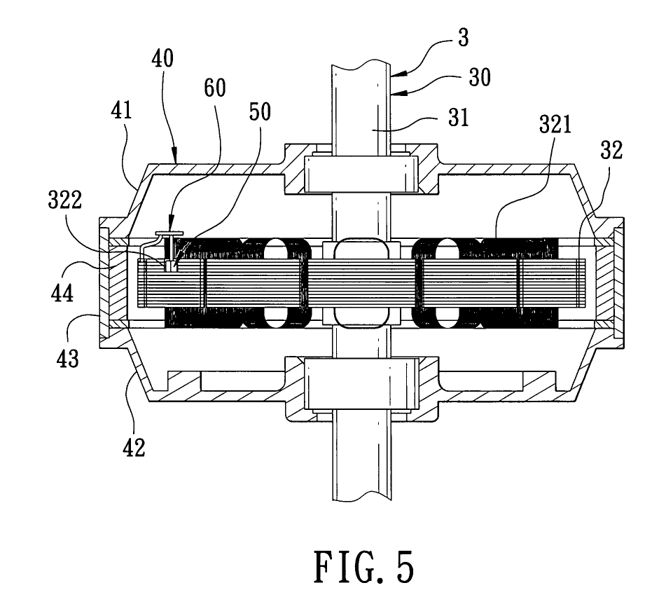

FIG. 6 is a cross-sectional view of the first preferred embodiment of a positioning device for a detecting device of a motor of a ceiling fan in the present invention, showing it being working;

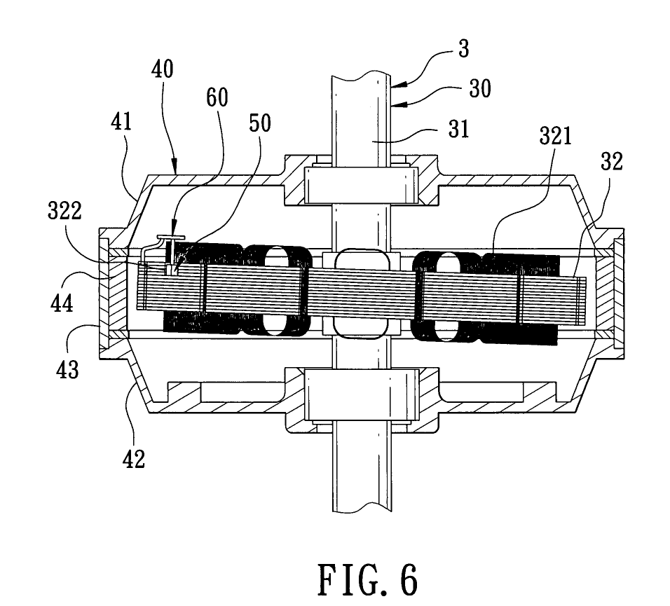

FIG. 7 is a cross-sectional view of a second preferred embodiment of a positioning device for a detecting device of a motor of a ceiling fan in the present invention, showing it being working; and

FIG. 8 is a partial magnified cross-sectional view of a third preferred embodiment of a positioning device for a detecting device of a motor of a ceiling fan in the present invention, showing it being working.

### DETAILED DESCRIPTION OF THE PREFERRED EMBODIMENT

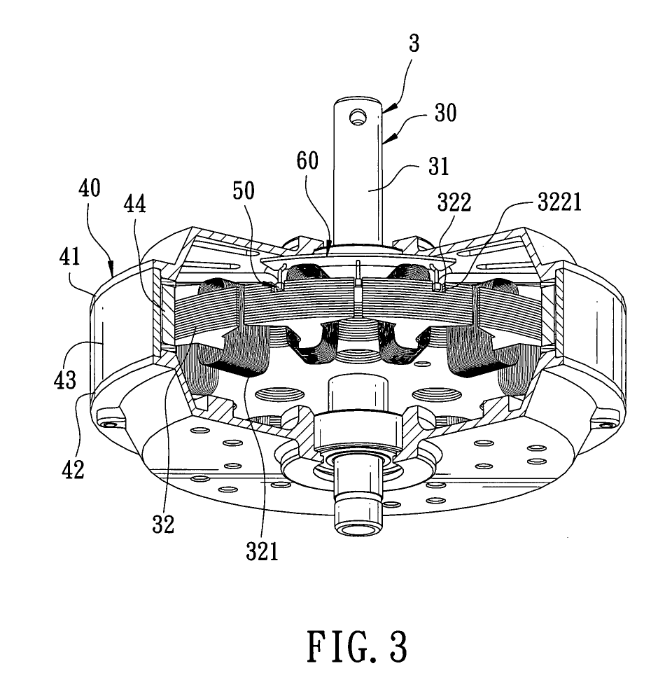

FIGS. 3˜5 show a first preferred embodiment of a positioning device for a detecting device of a motor 3 of a ceiling fan in the present invention. The motor 3 is composed of a stator 30, a rotor 40, a detecting device 50 and a circuit board 60.

The stator 30 is provided with a motor shaft 31, and a preset number of silica steel plates 32 that are laminated and installed around the circumference of the motor shaft 31, spaced apart with equidistance. A plurality of sections of the laminated silica steel plates 32 are respectively wound with a magnet coil 321. There are also three supporting recesses 322 cut in the top of the laminated silica steel plates 32 through to the edge. Or, the supporting recesses 322 are formed by having several upper silica steel plates 32 cut with recesses 3221 in advance and laminated to keep them aligned to form the supporting recesses 322.

The rotor 40 is pivotally set around the motor shaft 31 of the stator 30, provided with an upper shell 41, a lower shell 42, an intermediate shell 43 and a preset number of induction magnets 44 that are installed on the inner wall of the intermediate shell 43, corresponding to the circumference of the stator 30.

The detecting device 50 is composed of three Hall elements that are to be fitted in the supporting recesses 322.

The circuit board 60 is fixed above and connected with the detecting device 50.

As shown in FIGS. 3˜6, the detecting device 50 is tightly fitted in the supporting recesses 322. Or, the recesses 322 can be additionally coated with an adhesive to keep the detecting device 50 fixed more deadly therein. Therefore, when the induction magnets 44 are activated to rotate by the rotor 40, they can induce mutually with the detecting device 50 that can transmit signals to the circuit board 60 to enable the magnet coils 321 of the stator 30 to create an induced magnetic field, so as to activate the rotor 40 to steadily whirl in a same direction without shaking.

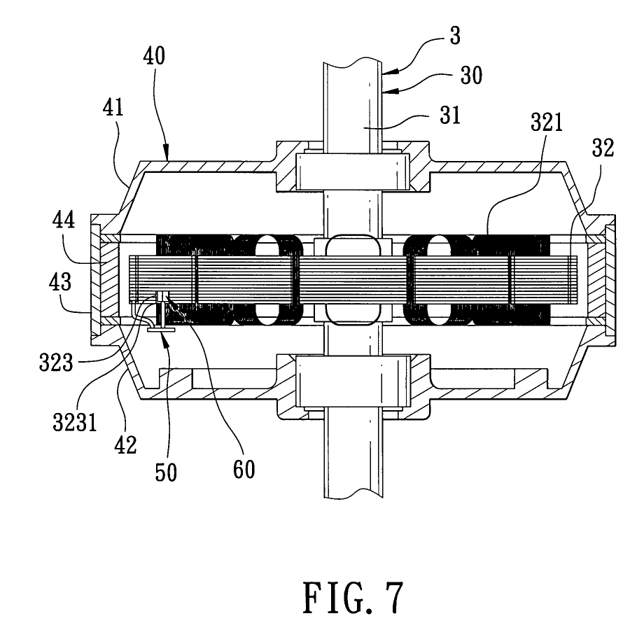

As shown in FIG. 7, a second preferred embodiment of a positioning device for a detecting device of a motor 3 of a ceiling fan in the present invention has the same components as the first embodiment does, except that the supporting recesses 322 for the detecting device 50 to be fitted therein are cut in the bottom of the laminated silica steel plates 32 through to the edge. And, like the first embodiment, the supporting recesses 322 are formed by having several lower silica steel plates 32 respectively cut with recesses 3221 in advance and then laminated to keep them aligned to form the supporting recesses 322.

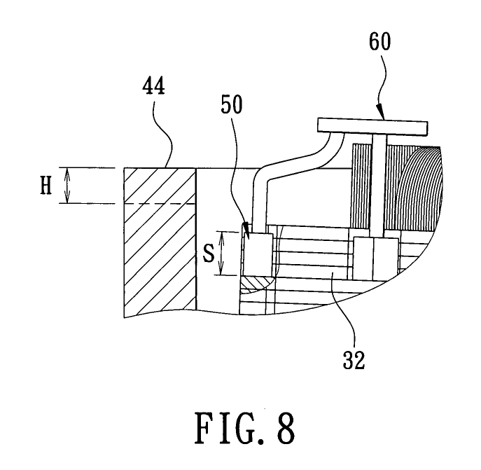

As shown in FIG. 8, a third preferred embodiment of a positioning device for a detecting device of a motor 3 of a ceiling fan in the present invention has the same components as the first embodiment does, except that the end of each of the induction magnets 44, corresponding to the top of the detecting device 50, is extended upwards with an at least 2 mm preset length to form a detecting zone (H) located at a level higher than that of a detectable range (S) of the detecting device 50. So, when the induction magnets 44 are activated to rotate by the rotor 40, they can surely induce with the detecting device 50 completely without any error owing to the detecting zone (H), so that the detecting device 50 can detect steadily to transmit signals to the circuit 60.

The invention has the following advantages as can be seen from the foresaid description.

1. The detecting device 50 is only precisely fitted in the supporting recesses 322 deadly, without advancing any cost.

2. By means of an adhesive coated easily in the recesses 322, the detecting device 50 is fixed in the supporting recesses 322 more tightly, achieving a more competitive product.

While the preferred embodiment of the invention has been described above, it will be recognized and understood that various modifications may be made therein and the appended claims are intended to cover all such modifications that may fall within the spirit and scope of the invention.

What is claimed is:

1. A positioning device for a detecting device of a motor of a ceiling fan, said motor at least comprising:
a stator including a motor shaft pivotally connected with;
a rotor pivotally set around said motor shaft of said stator and provided with an upper shell, a lower shell, an intermediate shell, and a preset number of induction magnets that are fixed on an inner wall of said intermediate shell to correspond to a circumference of said stator; and
said motor characterized by that said stator is provided with plural supporting recesses cut in preset locations of its one surface through to its edge for fitting said detecting device therein.

2. The positioning device for a detecting device of a motor of a ceiling fan as claimed in claim 1, wherein said stator is composed of a preset number of silica steel plates laminated and said supporting recesses are located on preset positions of one surface of said laminated silica steel plates.

3. The positioning device for a detecting device of a motor of a ceiling fan as claimed in claim 2, wherein said supporting recesses are located in grooves formed in a top surface of said laminated silica steel plates.

4. The positioning device for a detecting device of a motor of a ceiling fan as claimed in claim 3, wherein some upper ones of said laminated silica steel plates are respectively cut with recesses in advance and then laminated to keep said recesses aligned to form said supporting recesses.

5. The positioning device for a detecting device of a motor of a ceiling fan as claimed in claim 2, wherein said supporting recesses are located in grooves formed in a bottom surface of said silica steel plates.

6. The positioning device for a detecting device of a motor of a ceiling fan as claimed in claim 5, wherein some bottom ones of laminated said silica steel plates are cut with recesses in advance and then laminated to keep said recesses aligned to form said supporting recesses.

7. The positioning device for a detecting device of a motor of a ceiling fan as claimed in claim 1, wherein said supporting recesses are additionally coated with an adhesive to keep said detecting device stuck more tightly therein after fitted with said detecting device.

8. The positioning device for a detecting device of a motor of a ceiling fan as claimed in claim 1, wherein said detecting device is composed of Hall elements.

9. The positioning device for a detecting device of a motor of a ceiling fan as claimed in claim 1, wherein the end of each of said induction magnets corresponding to the end of said detecting device is extended with a preset length to form a zone for covering a detectable range of said detecting device, enabling said induction magnets to surely induce with said detecting device completely.

10. The positioning device for a detecting device of a motor of a ceiling fan as claimed in claim 9, wherein said preset length of said detected device is at least 2 mm.
